(19) United States
(12) Patent Application Publication
(10) Pub. No.: US 2001/0027073 A1
(43) Pub. Date: Oct. 4, 2001

(54) Non-asbestos friction materials

(76) Inventors: Mitsuru Kobayashi, Gunma-ken (JP); Shinya Sawamura, Gunma-ken (JP)

Correspondence Address: BIRCH STEWART KOLASCH & BIRCH, PO BOX 747, FALLS CHURCH, VA, 22040-0747, US

(21) Appl. No.: 09/796,480

(22) Filed: Mar. 2, 2001

(30) Foreign Application Priority Data
Mar. 3, 2000 (JP) 2000-058352

(51) Int. Cl. B32B 5/02; B32B 27/04; B32B 27/12; D04H 3/00

(52) U.S. Cl. 442/130; 428/292.1

(57) ABSTRACT

A non-asbestos friction material is made by molding and curing a composition comprising a fibrous base, a filler and a binder. The filler is at least partially composed of 1-35 vol %, based on the overall composition, of high-tar cashew dust having a tar content of at least 10 wt %. When used as a brake lining in drum brakes, for example, the friction material exhibits low wear during high-speed braking, excellent heat resistance, stable braking effectiveness and good strength.

### BACKGROUND OF THE INVENTION

1. Field of the Invention

The present invention relates to non-asbestos friction materials which are particularly well suited for use as brake linings in drum brakes because they undergo little wear during high-speed braking and have an excellent heat resistance, a stable braking performance and good strength.

2. Prior Art

Drum brake friction materials used for braking in automobiles, large trucks, railroad cars and various industrial equipment are required to have a number of performance features. These features include not only an excellent braking effectiveness (i.e., a high friction coefficient), but also a high heat resistance, minimal noise generation, and good strength to prevent cracks from forming when the friction material is bolted or riveted to the brake shoe.

Unlike in disk brakes, the brake shoe and brake lining in drum brakes are situated at the interior of the drum, making it difficult for heat generated during braking to dissipate to the exterior. As a result, the brake shoe and the friction material at the surface of the brake lining are scorched by heat, which greatly reduces braking effectiveness and tends to lead to brake fade. Accordingly, there is a strong desire for better heat resistance.

Moreover, the development of extensive highway networks and the increased use of long-distance transportation in recent years have brought about a sharp rise in the frequency of high-speed braking, greatly increasing both the amount of wear by the brake linings and, owing to the thermal history, the frequency of cracking at the surface of the lining against which the brake drum rubs.

Various attempts have been made to resolve these problems in frictional materials for drum brakes. Such efforts have included adding a large amount of graphite as a lubricant to reduce noise (in which case the amount of binder also increases), enhancing heat resistance by adding cashew dust that discharges little tar when heated, and including a higher proportion of binder to improve the strength of the friction material.

However, none of these approaches has succeeded in providing friction materials for drum brakes with all the desired performance features. Indeed, the prospects for developing in particular a friction material for drum brakes endowed with low wear during high-speed braking, stable brake effectiveness, and excellent heat resistance have been regarded as very poor.

### SUMMARY OF THE INVENTION

Therefore, the object of the present invention is to provide a high-quality non-asbestos friction material having low wear during high-speed braking, excellent heat resistance, stable braking effectiveness and good strength.

The inventor has found that, in non-asbestos friction materials, incorporating high-tar cashew dust and lowering the amount of binder are effective ways for achieving reduced wear during high-speed braking, improved heat resistance and other desirable aims.

That is, in non-asbestos friction materials obtained by molding and curing a composition comprising a fibrous base, a filler and a binder, the incorporation of 1 to 35 vol % of a high-tar cashew dust having a tar content of at least 10 wt % (the tar content in conventional cashew dust is 6 to 8 wt %) as at least part of the filler results in the formation by the high-tar cashew dust of a thin, uniform organic film on the friction surface, thereby reducing the amount of friction material wear during high-speed braking and stabilizing braking effectiveness. Also, by having the amount V₁ of graphite present as part of the filler and the total amount V₂ of binder present in the friction material composition (both amounts being expressed in volume percent based on the overall composition) be such that the product V₁×V₂ is greater than 100 and up to 190 and the sum V₁+V₂ is from 20 to 40 inclusive, the content of organic components, and in particular the amount of binder included in the composition, can be held much lower than in the prior art, making it possible to improve heat resistance. As a result, there can be obtained a high-quality non-asbestos friction material having low wear during high-speed braking, excellent heat resistance, stable braking effectiveness and a strength sufficient to prevent crack formation when the friction material is bolted or otherwise mounted on a brake shoe.

The inventor has also found that, in non-asbestos friction materials intended for use in drum brakes and obtained by molding and curing a composition comprising a fibrous base, a filler and a binder, when the filler is at least partially composed of 1 to 35 vol % of high-tar cashew dust and at least 5 vol % of graphite, and when the binder is included in a total amount of at most 30 vol %, based on the overall composition, these components work together to lower the amount of wear. As a result, in spite of the presence of a much lower amount of binder than in prior-art non-asbestos friction materials, or rather because of the presence of binder in such a small amount, the friction material has a vastly improved heat resistance. Hence, there can be obtained a high-quality non-asbestos friction material having low wear during high-speed braking, excellent heat resistance, stable braking effectiveness and good strength.

Therefore, according to a first aspect, the invention provides a non-asbestos friction material comprising a molded and cured composition which includes a fibrous base, a filler and a binder; wherein the filler is at least partially composed of 1 to 35 vol % of high-tar cashew dust, based on the overall composition, which cashew dust has a tar content of at least 10 wt %.

According to a second aspect, the invention provides a non-asbestos friction material comprising a molded and cured composition which includes a fibrous base, a filler and a binder; wherein the filler is at least partially composed of a high-tar cashew dust having a tar content of at least 10 wt % and graphite, the graphite is present in an amount V₁, and the binder is present in a total amount V₂, the amounts V₁ and V₂ being expressed in volume percent of the overall composition, such that the product V₁×V₂ is greater than 100 and up to 190 and the sum V₁+V₂ is from 20 to 40 inclusive.

### DETAILED DESCRIPTION OF THE INVENTION

The non-asbestos friction material of the invention is made by molding and curing a non-asbestos friction material composition composed primarily of a fibrous base, a filler and a binder. In a first embodiment of the invention, the filler is at least partially composed of 1 to 35 vol % (based on the overall composition) of a high-tar cashew dust having a tar content of at least 10 wt %, which gives the inventive material a vastly improved performance during high-speed braking.

The high-tar cashew dust has a tar content of at least 10 wt %, preferably 10 to 15 wt %, and most preferably 10 to 13 wt %. Too low a tar content fails to result in the formation of a thin, uniform film on the friction surface, preventing the intended objects and advantages of the invention from being achieved. “Tar content,” as used herein, refers to the weight percent of tar in the cashew dust, as measured by extraction with acetone. The tar content of the high-tar cashew dust used in the invention is significantly higher than the tar content of conventional cashew dust, which is typically 6 to 8 wt %. The high-tar cashew dust has an average particle size of preferably 50 to 500 μm, and especially 200 to 500 μm.

The high-tar cashew dust is included in an amount of 1 to 35 vol %, preferably 5 to 30 vol %, more preferably 5 to 25 vol %, and most preferably 5 to 20 vol %, based on the overall friction material composition. If the amount of high-tar cashew dust is outside the above range, the inventive friction material having a low amount of wear during high-speed braking and stable braking effectiveness cannot be achieved.

In a second embodiment of the invention, the filler consists in part of graphite present in an amount V₁, and the binder is present in a total amount V₂, the amounts V₁ and V₂ being expressed in percent by volume of the overall composition, such that the product V₁×V₂ is greater than 100 and up to 190 and the sum V₁+V₂ is from 20 to 40 inclusive (that is, 100<V₁×V₂≦190 and 20≦V₁+V₂≦40).

The product V₁×V₂ is preferably from 110 to 180, more preferably from 120 to 170, and most preferably from 130 to 170. The sum V₁+V₂ , which represents the combined amount of binder and graphite, is preferably from 25 to 40, more preferably from 25 to 35, and most preferably from 25 to 33.

If the amount of graphite V₁ and the total amount of binder V₂ (both in volume percent) are such that the product V₁×V₂ and the sum V₁+V₂ do not fall within the above ranges, the amount of organic components in the friction material becomes too large, lowering the heat resistance and compromising the performance during high-speed braking.

The graphite used in the non-asbestos friction material of the invention may be any known graphite commonly used in friction materials. The graphite may be a naturally produced or synthetic graphite, and may be in any form, such as scales, needles or spheres. The graphite has an average particle size of preferably 30 to 1,000 μm, and especially 50 to 500 μm.

The graphite is included in an amount V₁, based on the overall friction material composition, of at least 5 vol %, preferably 5 to 15 vol %, more preferably 5 to 10 vol %, and most preferably 5 to 8 vol %. The addition of too much graphite lowers the amount of binder and compromises the effects that are achieved by reducing the amount of organic components.

The binder may be any known binder commonly used in friction materials. Illustrative examples include phenolic resins, various rubber-modified phenolic resins such as high-ortho phenolic resins modified with acrylonitrile-butadiene rubber (NBR), NBR-modified phenolic resins and acrylic rubber-modified phenolic resins, and also melamine resins, epoxy resins, NBR, nitrile rubber and acrylic rubber. Any one or combinations of two or more of these may be used. The binder is included in a total amount V₂ which is up to 30 vol %, preferably 5 to 30 vol %, more preferably 5 to 27 vol %, even more preferably 10 to 27 vol %, and most preferably 15 to 25 vol %, based on the overall amount of the friction material composition. Too large a total amount V₂ of the binder excessively increases the organic components within the friction material, lowering the heat resistance.

In addition to the above-described high-tar cashew dust and graphite, the friction material of the invention may include also other known organic or inorganic fillers commonly used in friction materials. Illustrative examples include molybdenum disulfide, antimony trisulfide, calcium carbonate, precipitated calcium carbonate, barium sulfate, magnesium oxide, calcium hydroxide, calcium fluoride, slaked lime, talc, molybdenum trioxide, antimony trioxide, zirconium silicate, iron oxide, mica, iron sulfide, zirconium oxide, metal powder, fused silica, silicon dioxide, alumina, chromium oxide, vermiculite, ground tire rubber, rubber dust (rubber powder and granules), graphite, nitrile rubber dust (vulcanized product), and acrylic rubber dust (vulcanized product). These may be used alone or as combinations of two or more thereof.

The amount of such fillers other than high-tar cashew dust and graphite is preferably from 10 to 60 vol %, and especially from 25 to 50 vol %, based on the overall frictional material composition.

The fibrous base may be any organic fiber or inorganic fiber other than asbestos that is commonly used in friction materials. Illustrative examples of suitable materials include inorganic fibers such as metal fibers (e.g., iron, copper, brass, bronze, and aluminum), ceramic fibers, potassium titanate fibers, glass fibers, carbon fibers, rock wool, wollastonite, sepiolite, attapulgite, and man-made mineral fibers; and organic fibers such as aramid fibers, polyimide fibers, polyamide fibers, phenolic fibers, cellulose, and acrylic fibers. Any one or combination of two or more of these may be used.

The fibrous base may be used in the form of short fibers or a powder. It is added in an amount of preferably 5 to 30 vol %, and most preferably 10 to 20 vol %, based on the overall friction material composition.

The method of making the non-asbestos friction material of the invention involves uniformly blending the above-described fibrous base, fillers and binder in a suitable mixer such as a Henschel mixer, Loedige mixer or Eirich mixer, and preforming the blend in a mold. The preform is then molded at a temperature of 130 to 200° C. and a pressure of 100 to 1,000 kg/cm² for a period of 2 to 15 minutes. The resulting molded article is postcured by heat-treating at 140 to 250° C. for 2 to 48 hours, then spray-painted, baked and ground as needed, giving the finished article.

In the case of automotive brake linings, production may be carried out by known methods.

The non-asbestos friction materials of the invention can be used in disk brakes or drum brakes, and are highly suitable for a variety of related applications, including disk pads, brake shoes and brake linings in automobiles, large trucks, railroad cars and various types of industrial equipment. They are particularly well-suited to use as brake linings in drum brakes.

### EXAMPLES

Examples and comparative examples are given below by way of illustration, and are not intended to limit the invention.

### Examples and Comparative Examples

The friction material compositions shown in Tables 1 and 2 were formulated, then uniformly blended in a Loedige mixer and preformed in a pressure mold under a pressure of 100 kg/cm³ for 10 minutes. Each preform was molded for the desired length of time at a temperature and pressure of 160° C. and 250 kg/cm², then postcured by 5 hours of heat treatment at 200° C., yielding brake linings for drum brakes in each of Examples 1 to 11 and Comparative Examples 1 to 5.

The brake linings obtained in the examples were subjected to wear tests, strength tests, heat resistance tests and noise tests by the methods described below. The results are presented in Tables 1 and 2.

(1) Wear Test (According to JASO C407)

Test conditions were initial braking speed, 120 km/h; final braking speed, 60 km/h; braking deceleration, 0.25 g; number of braking cycles, 500; brake temperature before braking, 150° C. The amount of brake lining wear was measured.

(2) Strength Test

The degree of cracking that occurred when the brake lining was bolted and riveted to the brake shoe was rated as follows.

Very Good: No cracks

Good: Very few cracks

Fair: Relatively small number of cracks

Poor: Many cracks

(3) Heat-Resistance Test (JASO C407)

Test conditions were initial braking speed, 100 km/h; braking deceleration, 0.45 g; number of braking cycles, 15; brake temperature before braking, 150° C. The minimum friction coefficient was rated as follows:

Good: more than 0.25

Fair: 0.20 to 0.25

Poor: less than 0.20

(4) Noise Test (JASO C404)

The degree of noise and the frequency of noise generation were rated as follows in a road vehicle test.

Good: No noise

Fair: Slight noise

Poor: Moderate noise

TABLE 1

| | Examples of the invention | | | | | | | | | | |
|---|---|---|---|---|---|---|---|---|---|---|---|
| | 1 | 2 | 3 | 4 | 5 | 6 | 7 | 8 | 9 | 10 | 11 |
| Fibrous base | 14 | 14 | 14 | 14 | 14 | 14 | 14 | 14 | 14 | 14 | 14 |
| Organic Fillers | | | | | | | | | | | |
| Cashew dust A | 20 | 5 | 30 | | | 20 | 20 | 20 | 20 | 20 | 20 |
| Cashew dust B | | | | 20 | | | | | | | |
| Cashew dust C | | | | | 20 | | | | | | |
| Cashew dust D | | | | | | | | | | | |
| Cashew dust E | | | | | | | | | | | |
| Graphite | 7 | 7 | 7 | 7 | 7 | 7 | 7 | 7 | 7 | 7 | 7 |
| Rubber | 9 | 9 | 9 | 9 | 9 | 9 | 12 | 2 | 9 | 9 | 4 |
| (powder + granules) | | | | | | | | | | | |
| Binders | | | | | | | | | | | |
| Phenolic resin A | 23 | 23 | 23 | 23 | 23 | 20 | 16 | 24 | | | 25 |
| Phenolic resin B | | | | | | | | | 20 | | |
| Phenolic resin C | | | | | | | | | | 20 | |
| Inorganic | | | | | | | | | | | |
| Fillers | | | | | | | | | | | |
| Calcium carbonate | 12 | 17 | 5 | 12 | 12 | 14 | 15 | 16 | 14 | 14 | 14 |
| Barium sulfate | 5 | 5 | 2 | 5 | 5 | 5 | 5 | 2 | 5 | 5 | 5 |
| Slaked lime | 2 | 12 | 2 | 2 | 2 | 2 | 2 | 2 | 2 | 2 | 2 |
| Others | 8 | 8 | 8 | 8 | 8 | 9 | 9 | 13 | 9 | 9 | 9 |
| Total (vol %) | 100 | 100 | 100 | 100 | 100 | 100 | 100 | 100 | 100 | 100 | 100 |
| V₁ × V₂ | 161 | 161 | 161 | 161 | 161 | 140 | 112 | 168 | 140 | 140 | 175 |
| V₁ + V₂ | 30 | 30 | 30 | 30 | 30 | 27 | 23 | 31 | 27 | 27 | 32 |
| Amount of wear (mm) | 0.4 | 0.6 | 0.4 | 0.5 | 0.6 | 0.5 | 0.4 | 0.5 | 0.5 | 0.6 | 0.6 |
| Friction material | very | very | very | very | very | very | good | very | very | very | very |
| strength | good | good | good | good | good | good | | good | good | good | good |
| Heat resistance test | good | good | fair | good | good | good | good | good | good | good | fair |
| Noise test | good | fair | fair | good | good | good | good | fair | good | good | fair |

TABLE 2

| | | Comparative Examples | | | | |
|---|---|---|---|---|---|---|
| | | 1 | 2 | 3 | 4 | 5 |
| Fibrous base | | 14 | 14 | 14 | 14 | 14 |
| Organic | Cashew dust A | | | 20 | 20 | 20 |
| fillers | Cashew dust B | | | | | |
| | Cashew dust C | | | | | |
| | Cashew dust D | 20 | | | | |
| | Cashew dust E | | 20 | | | |
| | Graphite | 7 | 7 | 7 | 7 | 7 |
| | Rubber (powder + granules) | 9 | 9 | 12 | 2 | 8 |
| Binders | Phenolic resin A | 23 | 23 | 14 | 28 | 30 |
| | Phenolic resin B | | | | | |
| | Phenolic resin C | | | | | |
| Inorganic | Calcium carbonate | 12 | 12 | 16 | 14 | 14 |
| fillers | Barium sulfate | 5 | 5 | 5 | 5 | 5 |
| | Slaked lime | 2 | 2 | 2 | 2 | 2 |
| | Others | 8 | 8 | 10 | 8 | 0 |

| | | | | | |
|---|---|---|---|---|---|
| Total (vol %) | 100 | 100 | 100 | 100 | 100 |
| V₁ × V₂ | 161 | 161 | 98 | 196 | 210 |
| V₁ + V₂ | 30 | 30 | 21 | 35 | 37 |
| Amount of wear (mm) | 0.8 | 1.1 | 0.7 | 0.7 | 0.9 |
| Friction material strength | very | very | poor | very | very |
| | good | good | | good | good |
| Heat resistance test | good | good | good | fair | fair |
| Noise test | good | good | not | poor | poor |
| | | | measur- | | |
| | | | able | | |

In Tables 1 and 2, V₁ represents the amount of graphite in the respective compositions and V₂ represents the total amount of binder. Both values are expressed in volume percent based on the overall composition. The fibrous base in the above examples was a mixture of aramid fibers and glass fibers. In the tables, “Others” refers to other inorganic fillers such as precipitated calcium carbonate. Additional items in the tables are described below.

Cashew dust A: Tar content, 12 wt %; average particle size, approx. 400 μm

Cashew dust B: Tar content, 11 wt %; average particle size, approx. 400 μm

Cashew dust C: Tar content, 10 wt %; average particle size, approx. 400 μm

Cashew dust D: Tar content, 8 wt %; average particle size, approx. 360 μm

Cashew dust E: Tar content, 6 wt %; average particle size, approx. 360 μm

The tar contents in the cashew dusts were measured by acetone extraction.

Phenolic resin A: NBR rubber-modified high-ortho phenolic resin

Phenolic resin B: NBR rubber-modified phenolic resin

Phenolic resin C: Acrylic rubber-modified phenolic resin

Graphite: Average particle size, approx. 220 μm

As is apparent from the above results, the non-asbestos friction materials of the invention have low wear during high-speed braking, excellent heat resistance, stable braking effectiveness and good strength.

Japanese Patent Application No. 2000-058352 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A non-asbestos friction material obtained by molding and curing a composition comprising a fibrous base, a filler and a binder; wherein the filler is at least partially composed of 1 to 35 vol %, based on the overall composition, of high-tar cashew dust having a tar content of at least 10 wt %.

2. A non-asbestos friction material obtained by molding and curing a composition comprising a fibrous base, a filler and a binder; wherein the filler is at least partially composed of a high-tar cashew dust having a tar content of at least 10 wt % and graphite, the graphite is present in an amount V₁, and the binder is present in a total amount V₂, the amounts V₁ and V₂ each being expressed in volume percent of the overall composition, such that the product V₁×V₂ is greater than 100 and up to 190 and the sum V₁+V₂ is from 20 to 40 inclusive.

3. The non-asbestos friction material of claim 1 or 2, wherein the filler includes 1 to 35 vol % of high-tar cashew dust having a tar content of at least 10 wt % and at least 5 vol % of graphite, and the binder is present in a total amount of up to 30 vol %.
